(19) United States
(12) Patent Application Publication
(10) Pub. No.: US 2004/0032412 A1
(43) Pub. Date: Feb. 19, 2004

(54) Generating a graphical program based on a timing diagram

(76) Inventor: Brian Keith Odom, Georgetown, TX (US)

Correspondence Address: Jeffrey C. Hood, Conley, Rose, & Tayon, P.C., P.O. Box 398, Austin, TX, 78767, US

(21) Appl. No.: 10/320,014

(22) Filed: Dec. 16, 2002

Related U.S. Application Data
(60) Provisional application No. 60/403,134, filed on Aug. 13, 2002.

(51) Int. Cl. G06T 11/20

(52) U.S. Cl. 345/440

(57) ABSTRACT

A system and method for generating a graphical program based on a timing diagram created or specified by the user. The user may first draw a timing diagram on the display of a device that specifies timing relationship(s) among two or more signals. As a result, data structure(s) may be stored in memory which comprise information represented by the timing diagram. A graphical program may then be programmatically generated based on the timing diagram. For example, a graphical program generation (GPG) software program executing on the computer system may execute to analyze the timing diagram (e.g., analyze the stored data structure(s) that represent the timing diagram) and programmatically generate a graphical program that corresponds to the timing diagram. The generated graphical program may be configured to execute according to the timing diagram as drawn by the user.

### PRIORITY DATA

This application claims benefit of priority of provisional application Serial No. 60/403,134 titled “Generating a Graphical Program Based on a Timing Diagram” and filed on Aug. 13, 2002.

### FIELD OF THE INVENTION

The present invention relates to the field of graphical programming, and more particularly to a system and method for generating a graphical program based on a timing diagram.

### DESCRIPTION OF THE RELATED ART

Traditionally, high level text-based programming languages have been used by programmers in writing application programs. Many different high level programming languages exist, including BASIC, C, Java, FORTRAN, Pascal, COBOL, ADA, APL, etc. Programs written in these high level languages are translated to the machine language level by translators known as compilers or interpreters. The high level programming languages in this level, as well as the assembly language level, are referred to herein as text-based programming environments.

Increasingly, computers are required to be used and programmed by those who are not highly trained in computer programming techniques. When traditional text-based programming environments are used, the user's programming skills and ability to interact with the computer system often become a limiting factor in the achievement of optimal utilization of the computer system.

There are numerous subtle complexities which a user must master before he can efficiently program a computer system in a text-based environment. The task of programming a computer system to model or implement a process often is further complicated by the fact that a sequence of mathematical formulas, steps or other procedures customarily used to conceptually model a process often does not closely correspond to the traditional text-based programming techniques used to program a computer system to model such a process. In other words, the requirement that a user program in a text-based programming environment places a level of abstraction between the user's conceptualization of the solution and the implementation of a method that accomplishes this solution in a computer program. Thus, a user often must substantially master different skills in order to both conceptualize a problem or process and then to program a computer to implement a solution to the problem or process. Since a user often is not fully proficient in techniques for programming a computer system in a text-based environment to implement his solution, the efficiency with which the computer system can be utilized often is reduced.

Examples of fields in which computer systems are employed to interact with physical systems are the fields of instrumentation, process control, industrial automation, and simulation. Computer measurement and control of devices such as instruments or industrial automation hardware has become increasingly desirable in view of the increasing complexity and variety of instruments and devices available for use. However, due to the wide variety of possible testing and control situations and environments, and also the wide array of instruments or devices available, it is often necessary for a user to develop a custom program to control a desired system.

As discussed above, computer programs used to control such systems traditionally had to be written in text-based programming languages such as, for example, assembly language, C, FORTRAN, BASIC, etc. Traditional users of these systems, however, often were not highly trained in programming techniques and, in addition, text-based programming languages were not sufficiently intuitive to allow users to use these languages without training. Therefore, implementation of such systems frequently required the involvement of a programmer to write software for control and analysis of instrumentation or industrial automation data. Thus, development and maintenance of the software elements in these systems often proved to be difficult.

U.S. Pat. Nos. 4,901,221; 4,914,568; 5,291,587; 5,301,301; and 5,301,336; among others, to Kodosky et al disclose a graphical system and method for modeling a process, i.e., a graphical programming environment which enables a user to easily and intuitively model a process. The graphical programming environment disclosed in Kodosky et al can be considered a higher and more intuitive way in which to interact with a computer. A graphically based programming environment can be represented at a level above text-based high level programming languages such as C, Basic, Java, etc.

The method disclosed in Kodosky et al allows a user to construct a diagram using a block diagram editor. The block diagram may include a plurality of interconnected icons such that the diagram created graphically displays a procedure or method for accomplishing a certain result, such as manipulating one or more input variables and/or producing one or more output variables. In response to the user constructing a diagram or graphical program using the block diagram editor, data structures and/or program instructions may be automatically constructed which characterize an execution procedure that corresponds to the displayed procedure. The graphical program may be compiled or interpreted by a computer.

Therefore, Kodosky et al teaches a graphical programming environment wherein a user places or manipulates icons and interconnects or “wires up” the icons in a block diagram using a block diagram editor to create a graphical “program.” A graphical program for performing an instrumentation, measurement or automation function, such as measuring a Unit Under Test (UUT) or device, controlling or modeling instruments, controlling or measuring a system or process, or for modeling or simulating devices, may be referred to as a virtual instrument (VI). Thus, a user can create a computer program solely by using a graphically based programming environment. This graphically based programming environment may be used for creating virtual instrumentation systems, modeling processes, control, simulation, and numerical analysis, as well as for any type of general programming.

A graphical program may have a graphical user interface. For example, in creating a graphical program, a user may create a front panel or user interface panel. The front panel may include various graphical user interface elements or front panel objects, such as user interface controls and/or indicators, that represent or display the respective input and output that will be used by the graphical program or VI, and may include other icons which represent devices being controlled. The front panel may be comprised in a single window of user interface elements, or may comprise a plurality of individual windows each having one or more user interface elements, wherein the individual windows may optionally be tiled together. When the controls and indicators are created in the front panel, corresponding icons or terminals may be automatically created in the block diagram by the block diagram editor. Alternatively, the user can place terminal icons in the block diagram which may cause the display of corresponding front panel objects in the front panel, either at edit time or later at run time. As another example, the front panel may comprise front panel objects, e.g., the GUI, embedded in the block diagram.

During creation of the block diagram portion of the graphical program, the user may select various function nodes or icons that accomplish his desired result and connect the function nodes together. For example, the function nodes may be connected in one or more of a data flow, control flow, and/or execution flow format. The function nodes may also be connected in a “signal flow” format, which is a subset of data flow. The function nodes may be connected between the terminals of the various user interface elements, e.g., between the respective controls and indicators. Thus the user may create or assemble a graphical program, referred to as a block diagram, graphically representing the desired process. The assembled graphical program may be represented in the memory of the computer system as data structures and/or program instructions. The assembled graphical program, i.e., these data structures, may then be compiled or interpreted to produce machine language that accomplishes the desired method or process as shown in the block diagram.

Input data to a graphical program may be received from any of various sources, such as from a device, unit under test, a process being measured or controlled, another computer program, or from a file. Also, a user may input data to a graphical program or virtual instrument using a graphical user interface, e.g., a front panel as described above. The input data may propagate through the block diagram or graphical program and appear as changes on the output indicators. In an instrumentation application, the front panel can be analogized to the front panel of an instrument. In an industrial automation application the front panel can be analogized to the MMI (Man Machine Interface) of a device. The user may adjust the controls on the front panel to affect the input and view the output on the respective indicators. Alternatively, the user interface may be used merely to view the input and output, or just the output, and the input may not be interactively manipulable by the user during program execution.

Thus, graphical programming has become a powerful tool available to programmers. Graphical programming environments such as the National Instruments LabVIEW product have become very popular. Tools such as LabVIEW have greatly increased the productivity of programmers, and increasing numbers of programmers are using graphical programming environments to develop their software applications. In particular, graphical programming tools are being used for test and measurement, data acquisition, process control, man machine interface (MMI), supervisory control and data acquisition (SCADA) applications, simulation, image processing/machine vision applications, and motion control, among others.

As graphical programming environments have matured and grown in popularity and complexity, it has become increasingly desirable to provide high-level tools which help a user create a graphical program. It also becomes increasingly desirable to integrate graphical programming environments with other applications and programming environments. In order to provide the desired tools or the desired integration, it would be greatly desirable to provide the ability to dynamically or programmatically generate and/or modify a graphical program or a portion of a graphical program. For example, for various applications, it would be desirable to provide the user with an intuitive mechanism for specifying certain behavior, wherein the specified behavior can be used to programmatically generate or modify a graphical program (or portion of a graphical program).

As described above, a user typically creates a graphical program within a graphical programming environment by interactively or manually placing icons or nodes representing the desired blocks of functionality on a diagram, and connecting the icons/nodes together to represent one or more of the data flow, control flow, and/or execution flow of the program. The ability to programmatically generate or modify a graphical program in response to other types of user input would enable a graphical program to be more easily generated or modified.

### SUMMARY OF THE INVENTION

One embodiment of the present invention comprises a system and method for generating a graphical program based on a timing diagram created or specified by the user.

The user may first draw a timing diagram on the display of a device that specifies timing relationship(s) among two or more signals. In one embodiment, the user uses a system timing development tool to create the timing diagram. The user may create or draw the timing diagram on the display using any of various techniques, such as by using a mouse. For example, the user may create, draw or cause to be drawn various timing signals on the display. The signals drawn on the display may have various rising and/or falling edges (or pulses) which indicate different events. The user may specify the rising and/or falling edges of signals according to a timeline of the timing diagram. The user may also specify names of the various signals, and may specify devices which are to generate the signals. In one embodiment, the user may specify certain signals to be monitored during operation of the system.

The user may also specify relationships among various signals or various rising and/or falling edges of signals, e.g., by drawing a line or arrow between respective signals. By specifying a relationship between first and second signals, the user may be able to change timing relationships of other signals while not affecting the timing relationship of the first and second signals.

In creating the timing diagram, the user may also specify one or more GUI elements, such as controls and indicators. These GUI elements may be created in the graphical program that is programmatically generated. The GUI elements may correspond to parameters in the timing diagram that the user desires to interactively tune. These GUI elements allow adjustments to a previously compiled timing diagram without recompilation of the timing diagram.

As a result of the user creating the timing diagram on the display, data structure(s) may be stored in memory which comprise information represented by the timing diagram. The data structures may store information regarding the names of the signals; time locations of their respective rising and/or falling edges; amplitudes of the signals, frequency and/or phase of any periodic signals; dependency relationships of the signals; names and/or types of devices which are to generate respective signals; signals to be monitored (including information on how the signals are to be monitored); and other information contained in the timing diagram.

A graphical program may then be programmatically generated based on the timing diagram. For example, a graphical program generation (GPG) software program executing on the computer system may execute to analyze the timing diagram (e.g., analyze the stored data structure(s) that represent the timing diagram) and programmatically generate a graphical program that corresponds to the timing diagram. The GPG program may obtain the information on the names of he signals, time locations of their respective rising and/or falling edges, and the other information mentioned above as being stored in the data structure(s), and may use this information to programmatically generate the graphical program. For example, the generated graphical program may be configured to generate the two or more signals according to the timing specified in the timing diagram as drawn by the user. In one embodiment, after the user has drawn or specified the timing diagram, the user selects an option to invoke programmatic generation of a graphical program based on the timing diagram.

The graphical program may comprise a plurality of interconnected nodes which visually indicate functionality of the program. The graphical program may then be further edited by the user, incorporated into another program, or executed as is. The graphical program may also be deployed to any of various devices. In one embodiment, portions of the graphical program may be deployed onto a plurality of different devices. In one embodiment, the graphical program (or at least a portion of the graphical program) may be deployed onto a programmable hardware element, such as an FPGA.

In one embodiment, a link may be maintained between the graphical program and the timing diagram. Thus, in one embodiment the user can adjust tunable parameters represented by GUI elements in either the timing diagram or the graphical program. The link between the graphical program and the timing diagram may cause changes made in one of the timing diagram or the graphical program to be automatically reflected in the other. Providing a link between the timing diagram and an executing graphical program also enables various feedback methods to be used. For example, a user can overlay a received signal on the timing diagram or timing description and compare the original timing signal and the received signal. Further, the user can link monitored triggers back to the timing description.

In one embodiment, the method may operate to generate multiple programs from the timing diagram, e.g., one for an FPGA and one for a host computer. For example, the same timing diagram may be used to generate programs for each of two or more different targets, e.g., an FPGA and a host computer. Alternatively, different portions of one timing diagram may be used to generate programs for each of two or more different targets, wherein the programs may execute in a distributed fashion to implement the timing diagram.

In one embodiment, the user may link input events to output events, e.g., a handshake signal. The user can draw a line in the timing diagram from an input event (e.g., a trigger) to an output event to indicate a causal relationship between the input event and the output event. The program generated from the timing diagram will then implement this causal relationship. One example of this is a dependency from a monitor trigger to an output event or triggered event.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a network system comprising two or more computer systems that may implement an embodiment of the present invention;

FIG. 2A illustrates an instrumentation control system according to one embodiment of the invention;

FIG. 2B illustrates an industrial automation system according to one embodiment of the invention;

FIG. 3 is an exemplary block diagram of the computer systems of FIGS. 1, 1A, 2A and 2B;

FIG. 4 is a flowchart diagram illustrating one embodiment of a method for generating a graphical program based on a timing diagram;

FIG. 5 is a flowchart diagram illustrating one embodiment of a method for generating a graphical program based on a timing diagram;

FIG. 6 is a block diagram illustrating a “GPG program” programmatically generating a graphical program based on a timing diagram;

FIG. 7 is a block diagram illustrating the abstract relationship between a client program (a GPG program), an API to programmatically generate/edit a graphical program, and a server program;

FIGS. 8-13 are screen shots illustrating creation of a timing diagram according to one embodiment of the invention.

FIG. 14 is a screen shot illustrating the display after a test has been run using a graphical program generated based on the timing diagram of FIG. 13;

FIGS. 15-18 are screen shots illustrating different exemplary timing diagrams; and

FIG. 19 illustrates a graphical program generated based on a timing diagram.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

### Incorporation by Reference

The following references are hereby incorporated by reference in their entirety as though fully and completely set forth herein:

U.S. Pat. No. 4,914,568 titled “Graphical System for Modeling a Process and Associated Method,” issued on Apr. 3, 1990.

U.S. Pat. No. 5,481,741 titled “Method and Apparatus for Providing Attribute Nodes in a Graphical Data Flow Environment”.

U.S. Pat. No. 6,173,438 titled “Embedded Graphical Programming System” filed Aug. 18, 1997.

U.S. Pat. No. 6,219,628 titled “System and Method for Configuring an Instrument to Perform Measurement Functions Utilizing Conversion of Graphical Programs into Hardware Implementations,” filed Aug. 18, 1997.

U.S. patent application Ser. No. 09/518,492 titled “System and Method for Programmatically Creating a Graphical Program,” filed Mar. 3, 2000.

U.S. patent application Ser. No. 09/745,023 titled “System and Method for Programmatically Generating a Graphical Program in Response to Program Information,” filed Dec. 20, 2000.

U.S. patent application Ser. No. 09/595,003 titled “System and Method for Automatically Generating a Graphical Program to Implement a Prototype,” filed Jun. 13, 2000.

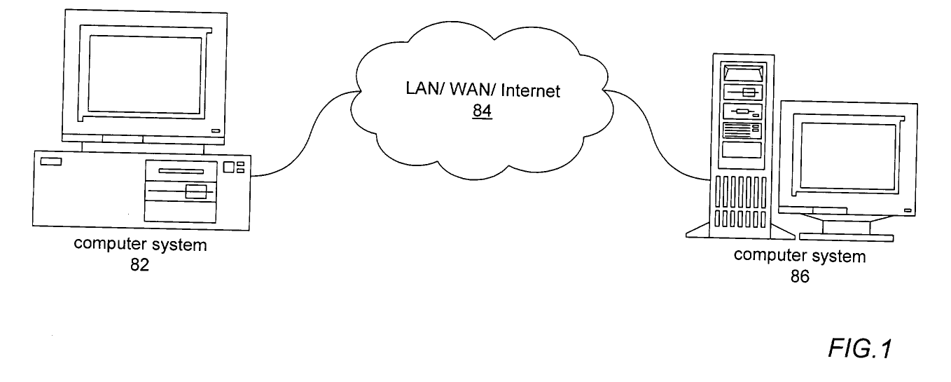

### FIG. 1—Computer System

FIG. 1 illustrates an exemplary computer system 82 operable to perform an embodiment of the invention. The computer system 82 may be used by a user to create a timing diagram that specifies timing relationships among various signals. The computer system 82 may also be operable to programmatically generate a graphical program based on the timing diagram created by the user. The computer system 82 may be a stand-alone system or operate in a stand-alone manner, i.e., without the services of other computer systems. Alternatively, the computer system 82 may be connected to a second computer system, e.g., computer system 86, over a network 84 (or through a computer bus). The network 84 can also be any of various types, including a LAN (local area network), WAN (wide area network), the Internet, or an Intranet, among others. In one embodiment, the computer system 82 may use the services of a second computer system, e.g., computer system 86, to perform at least a portion of the methods described herein. For example, a user may use the first computer system 82 to create a timing diagram. The second computer system 86 may operate to programmatically create a graphical program based on the timing diagram.

The computer system 82 may be any type of computer system, including a personal computer system, mainframe computer system, workstation, network appliance, Internet appliance, personal digital assistant (PDA), television system or other device. In general, the term “computer system” can be broadly defined to encompass any device having at least one processor that executes instructions from a memory medium. The computer system 82 may include various standard components, such as a processor, memory medium, input device (such as a mouse or keyboard), display device, etc. The computer system 82 may be used by a user to draw or otherwise create a timing diagram.

The computer system 82 may include a memory medium(s) on which one or more computer programs according to one embodiment of the present invention may be stored. For example, the memory medium may store a program for enabling a user to draw or otherwise specify a timing diagram. The program may enable a user to specify relationships among signals in the timing diagram.

The memory medium of the computer system 82 may also store a software program for generating a graphical program based on the timing diagram created by the user (e.g., a “GPG program” as described below). Also, the memory medium may store a graphical programming development environment application used to create and/or execute such graphical programs. The memory medium may also store operating system software, as well as other software for operation of the computer system.

The term “memory medium” is intended to include an installation medium, e.g., a CD-ROM, floppy disks 104, or tape device; a computer system memory or random access memory such as DRAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as networks and/or a wireless link.

The memory medium of the computer system 82 may include or store a computer program, referred to herein as a graphical program generation program, or a “GPG program”, that is operable to receive and/or analyze a timing diagram and programmatically generate a graphical program based on the program information. One embodiment of a method for programmatically generating a graphical program is described below.

In one embodiment, the GPG program may be implemented as a self-contained program or application that includes all necessary program logic for generating the graphical program. In another embodiment, the GPG program may comprise a client portion and a server portion (or client program and server program), wherein the client portion may request or direct the server portion to generate the graphical program. For example, the client portion may utilize an application programming interface (API) provided by the server portion in order to generate the graphical program. In other words, the client portion may perform calls to the API provided by the server portion, and the server portion may execute functions or routines bound to these calls to generate the graphical program. In one embodiment, the server portion may be an instance of a graphical programming environment application. For example, the LabVIEW graphical programming environment application enables client programs to interface with a LabVIEW server in order to programmatically generate or modify graphical programs.

As used herein, the term “GPG program” is intended to include any of various implementations of a program (or programs) that are executable to programmatically generate a graphical program based on received program information. For example, the term “GPG program” is intended to include an embodiment in which the GPG program is a self-contained program or application (not implemented as a client/server program) that includes all necessary program logic for programmatically generating a graphical program. The term “GPG program” is also intended to include an embodiment in which a combination of a client portion (or client program) and server portion (or server program) operate together to programmatically generate the graphical program. The term “GPG program” is also intended to include other program implementations.

In an embodiment in which a client program interfaces with a server program to generate the graphical program, the server program may execute on the same computer system as the client program or may execute on a different computer system, e.g., a different computer system connected via a network. For example, in FIG. 1, the client program may execute on the computer system 82, and the server program may execute on the computer system 86. In this case, the graphical program, e.g., files representing the graphical program may be created on the computer system 82, or 86, or on a different computer system.

It is noted that the GPG program may be implemented using any of various programming technologies or methodologies. Where the GPG program is implemented as client and server programs, each of these programs may utilize procedure-based techniques, component-based techniques, and/or object-oriented techniques, among others. The programs may be written using any combination of text-based or graphical programming languages. Also, the programs may be written using distributed modules or components so that each program may reside on any combination of computer system 82, computer system 86, and other computer systems connected to the network 84. Also, in various embodiments, the client program may interface with the server program through a proxy software component or program.

In the present application, the term “graphical program” or “block diagram” is intended to include a program comprising graphical code, e.g., two or more interconnected nodes or icons, wherein the interconnected nodes or icons may visually indicate the functionality of the program. The nodes may be connected in one or more of a data flow, control flow, and/or execution flow format. The nodes may also be connected in a “signal flow” format, which is a subset of data flow. Thus the terms “graphical program” or “block diagram” are each intended to include a program comprising a plurality of interconnected nodes or icons which visually indicate the functionality of the program.

A graphical program may also comprise a user interface or front panel. The user interface portion may be contained in the block diagram or may be contained in one or more separate panels or windows. The user interface of a graphical program may include various graphical user interface elements or front panel objects, such as user interface controls and/or indicators, that represent or display the respective input and/or output that will be used by the graphical program or VI, and may include other icons which represent devices being controlled. The user interface or front panel may be comprised in a single window of user interface elements, or may comprise a plurality of individual windows each having one or more user interface elements, wherein the individual windows may optionally be tiled together. As another example, the user interface or front panel may comprise user interface or front panel objects, e.g., the GUI, embedded in the block diagram. The user interface of a graphical program may display only output, only input, or both input and output. Further, in some embodiments the user interface or front panel of a graphical program may enable the user to interactively control or manipulate the input being provided to the graphical program.

Examples of graphical programming development environments that may be used to create graphical programs include LabVIEW, DasyLab, and DiaDem from National Instruments, VEE from Agilent, WiT from Coreco, Vision Program Manager from PPT Vision, SoftWIRE from Measurement Computing, Simulink from the MathWorks, Sanscript from Northwoods Software, Khoros from Khoral Research, SnapMaster from HEM Data, VisSim from Visual Solutions, ObjectBench by SES (Scientific and Engineering Software), and VisiDAQ from Advantech, among others. In the preferred embodiment, the system uses the LabVIEW graphical programming system available from National Instruments.

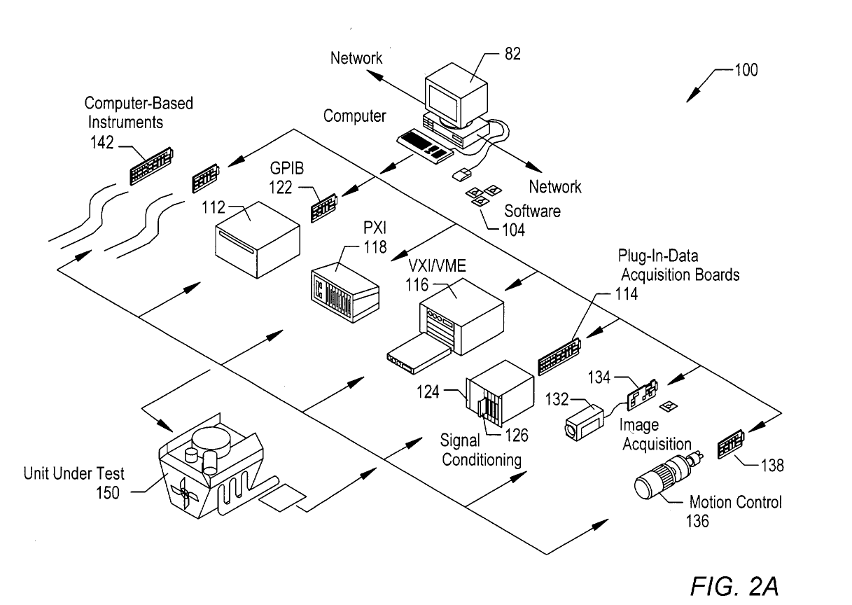

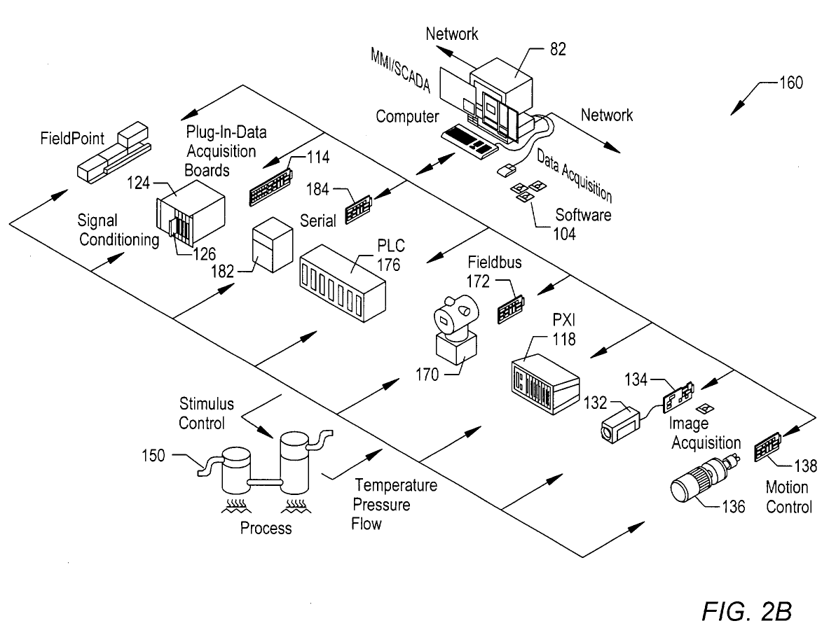

### FIGS. 2A and 2B—Instrumentation and Industrial Automation Systems

The following describes embodiments of the present invention involved with performing test and/or measurement functions and/or controlling and/or modeling instrumentation or industrial automation hardware. However, it is noted that the present invention can be used for a plethora of applications and are not limited to instrumentation or industrial automation applications. In other words, the following description is exemplary only, and the present invention may be used in any of various types of systems. Thus, the system and method of the present invention is operable to be used in any of various types of applications, including the control of other types of devices such as multimedia devices, video devices, audio devices, telephony devices, Internet devices, etc., as well as general purpose software applications such as word processing, spreadsheets, network control, games, etc.

FIG. 2A illustrates an exemplary instrumentation control system 100 which may implement embodiments of the invention. The system 100 comprises a host computer 82 which connects to one or more instruments. The host computer 82 may comprise a CPU, a display screen, memory, and one or more input devices such as a mouse or keyboard as shown. The computer 82 may operate with the one or more instruments to analyze, measure or control a unit under test (UUT) or process 150.

The one or more instruments may include a GPIB instrument 112 and associated GPIB interface card 122, a data acquisition board 114 and associated signal conditioning circuitry 124, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices.

The GPIB instrument 112 may be coupled to the computer 82 via the GPIB interface card 122 provided by the computer 82. In a similar manner, the video device 132 may be coupled to the computer 82 via the image acquisition card 134, and the motion control device 136 may be coupled to the computer 82 through the motion control interface card 138. The data acquisition board 114 may be coupled to the computer 82, and may interface through signal conditioning circuitry 124 to the UUT. The signal conditioning circuitry 124 may comprise an SCXI (Signal Conditioning eXtensions for Instrumentation) chassis comprising one or more SCXI modules 126.

The GPIB card 122, the image acquisition card 134, the motion control interface card 138, and the DAQ card 114 are typically plugged in to an I/O slot in the computer 82, such as a PCI bus slot, a PC Card slot, or an ISA, EISA or MicroChannel bus slot provided by the computer 82. However, these cards 122, 134, 138 and 114 are shown external to computer 82 for illustrative purposes. These devices may also be connected to the computer 82 through a serial bus or through other means.

The VXI chassis or instrument 116 may be coupled to the computer 82 via a VXI bus, MXI bus, or other serial or parallel bus provided by the computer 82. The computer 82 may include VXI interface logic, such as a VXI, MXI or GPIB interface card (not shown), which interfaces to the VXI chassis 116. The PXI chassis or instrument may be coupled to the computer 82 through the computer's PCI bus.

A serial instrument (not shown) may also be coupled to the computer 82 through a serial port, such as an RS-232 port, USB (Universal Serial bus) or IEEE 1394 or 1394.2 bus, provided by the computer 82. In typical instrumentation control systems an instrument will not be present of each interface type, and in fact many systems may only have one or more instruments of a single interface type, such as only GPIB instruments.

The instruments may be coupled to a unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application.

FIG. 2B illustrates an exemplary industrial automation system 160 which may implement embodiments of the invention. The industrial automation system 160 is similar to the instrumentation or test and measurement system 100 shown in FIG. 2A. Elements which are similar or identical to elements in FIG. 2A have the same reference numerals for convenience. The system 160 may comprise a computer 82 which connects to one or more devices or instruments. The computer 82 may comprise a CPU, a display screen, memory, and one or more input devices such as a mouse or keyboard as shown. The computer 82 may operate with the one or more devices to a process or device 150 to perform an automation function, such as MMI (Man Machine Interface), SCADA (Supervisory Control and Data Acquisition), portable or distributed data acquisition, process control, advanced analysis, or other control.

The one or more devices may include a data acquisition board 114 and associated signal conditioning circuitry 124, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

The DAQ card 114, the PXI chassis 118, the video device 132, and the image acquisition card 134 may be connected to the computer 82 as described above. The serial instrument 182 may be coupled to the computer 82 through a serial interface card 184, or through a serial port, such as an RS-232 port, provided by the computer 82. The PLC 176 may couple to the computer 82 through a serial port, Ethernet port, or a proprietary interface. The fieldbus interface card 172 may be comprised in the computer 82 and may interface through a fieldbus network to one or more fieldbus devices. Each of the DAQ card 114, the serial card 184, the fieldbus card 172, the image acquisition card 134, and the motion control card 138 are typically plugged in to an I/O slot in the computer 82 as described above. However, these cards 114, 184, 172, 134, and 138 are shown external to computer 82 for illustrative purposes. In typical industrial automation systems a device will not be present of each interface type, and in fact many systems may only have one or more devices of a single interface type, such as only PLCs. The devices may be coupled to the device or process 150.

As used herein, the term “instrument” is intended to include any of the devices that are adapted to be connected to a computer system as shown in FIGS. 2A and 2B, traditional “stand-alone” instruments, as well as other types of measurement and control devices. The term “measurement function” may include any type of data acquisition, measurement or control function, such as that implemented by the instruments shown in FIGS. 2A and 2B. For example, the term “measurement function” includes acquisition and/or processing of an image. As described below, a graphical program may be created that implements a measurement function. For example, the graphical program may be used to acquire a signal and perform the measurement function on the acquired signal.

In the embodiments of FIGS. 2A and 2B above, one or more of the various instruments may couple to the computer 82 over a network, such as the Internet. In one embodiment, the user operates to select a target instrument or device from a plurality of possible target devices for programming or configuration according to the present invention. Thus the user may create or deploy a graphical program on a computer and use the graphical program in conjunction with a target device or instrument that is remotely located from the computer and coupled to the computer through a network.

Graphical software programs which perform data acquisition, analysis and/or presentation, e.g., for measurement, instrumentation control, industrial automation, or simulation, such as in the applications shown in FIGS. 2A and 2B, may be referred to as virtual instruments.

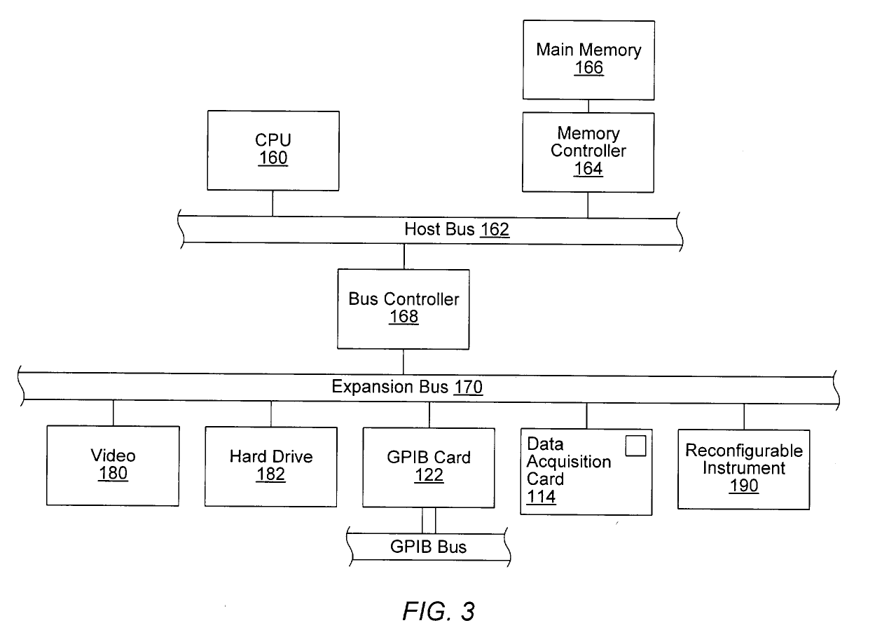

### FIG. 3—Computer System Block Diagram

FIG. 3 is a block diagram representing one embodiment of the computer system 82 and/or 90 illustrated in FIGS. 1 and 1A, or computer system 82 shown in FIGS. 2A or 2B. It is noted that any type of computer system configuration or architecture can be used as desired, and FIG. 3 illustrates a representative PC embodiment. It is also noted that the computer system may be a general purpose computer system, a computer implemented on a VXI card installed in a VXI chassis, a computer implemented on a PXI card installed in a PXI chassis, or other types of embodiments. Elements of a computer not necessary to understand the present description have been omitted for simplicity.

The computer may include at least one central processing unit or CPU 160 which is coupled to a processor or host bus 162. The CPU 160 may be any of various types, including an x86 processor, e.g., a Pentium class, a PowerPC processor, a CPU from the SPARC family of RISC processors, as well as others. Main memory 166 is coupled to the host bus 162 by means of memory controller 164. The main memory 166 may comprise a memory medium which stores the programs described above. The main memory may also store operating system software, as well as other software for operation of the computer system.

The host bus 162 may be coupled to an expansion or input/output bus 170 by means of a bus controller 168 or bus bridge logic. The expansion bus 170 may be the PCI (Peripheral Component Interconnect) expansion bus, although other bus types can be used. The expansion bus 170 includes slots for various devices such as a data acquisition board 114 and a GPIB interface card 122 which provides a GPIB bus interface to a GPIB instrument. The computer 82 further comprises a video display subsystem 180 and hard drive 182 coupled to the expansion bus 170.

As shown, a device, such as reconfigurable instrument 190, may also be connected to the computer. The reconfigurable instrument 190 may include configurable logic, such as a programmable logic device, e.g., an FPGA, or a processor and memory, which may execute a real time operating system. According to one embodiment, a created graphical program may be deployed on the reconfigurable instrument 190. In various embodiments, the configurable logic may be comprised on an instrument or device connected to the computer through means other than an expansion slot, e.g., the instrument or device may be connected via an IEEE 1394 bus, USB, or other type of port, or may be connected via a network. Also, the configurable logic may be comprised on a device such as the data acquisition board 114 or another device shown in FIG. 2A or 2B, or another device not shown.

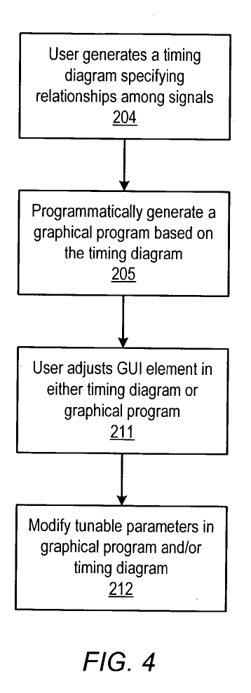

### FIG. 4—Programmatic Creation of a Graphical Program From a Timing Diagram

FIG. 4 is a high level flowchart illustrating one embodiment of the invention.

As shown, in 204 the user may create a timing diagram. As used herein, the term “timing diagram” refers to a diagram displayed on a display device that displays two or more signals, and which displays a timing relationship among the two or more signals. The “timing diagram” may include a horizontal time axis that specifies a timeline for the two or more signals. In one embodiment, the user may also specify or draw a relationship among two or more signals. Thus in step 204 the user may draw a timing diagram on the display of a device that specifies timing relationship(s) among two or more signals.

In one embodiment, the user may use a timing diagram design tool in creating the timing diagram. The user may create or draw the timing diagram on the display using any of various techniques, such as by using a mouse. For example, the user may create, draw, or cause to be drawn various timing signals on the display. The signals drawn on the display may have various rising and/or falling edges (or pulses) which indicate different events. The user may specify the rising and/or falling edges of signals according to a timeline of the timing diagram. The user may also specify names of the various signals, and may specify devices which are to generate the signals. In one embodiment, the user may specify certain signals to be monitored during operation of the system.

The user may also specify relationships among various signals or various rising and/or falling edges of signals, e.g., by drawing a line or arrow between respective signals. By specifying a relationship between first and second signals, the user may be able to change timing relationships of other signals while not affecting the timing relationship of the first and second signals.

In creating the timing diagram, the user may also specify one or more GUI elements, such as controls and indicators. These GUI elements may be created in the graphical program that is programmatically generated. The GUI elements may correspond to parameters in the timing diagram that the user desires to interactively tune. These GUI elements allow adjustments to a previously compiled timing diagram without recompilation of the timing diagram.

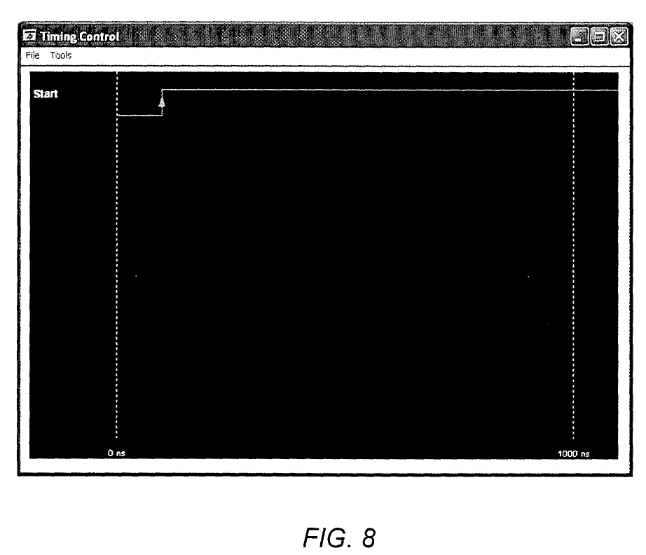

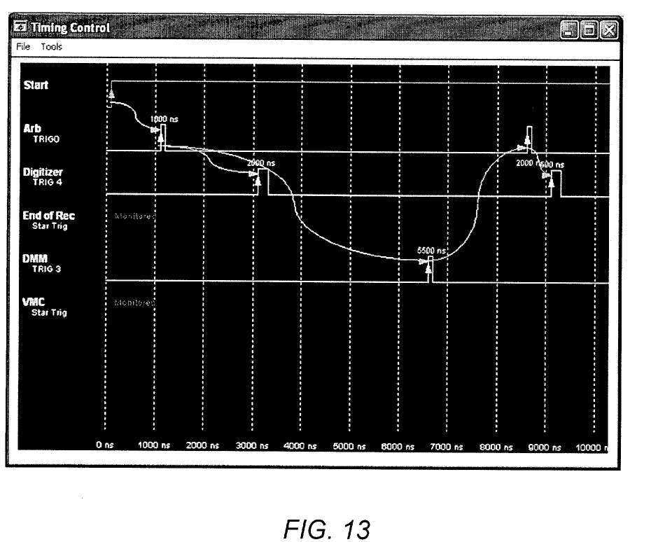

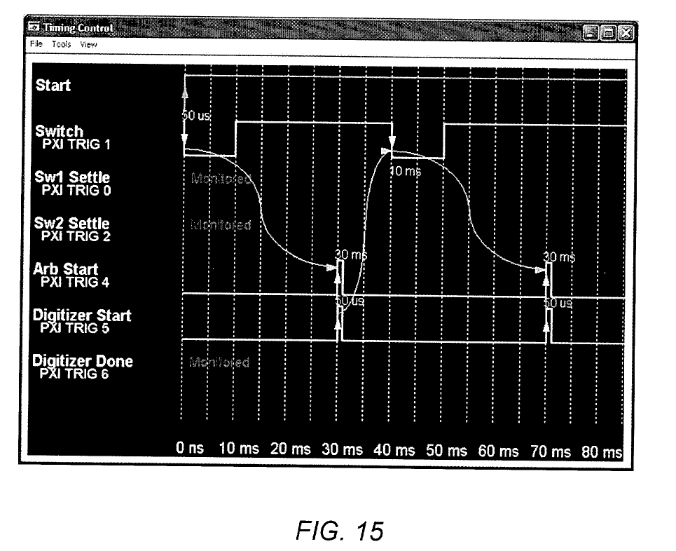

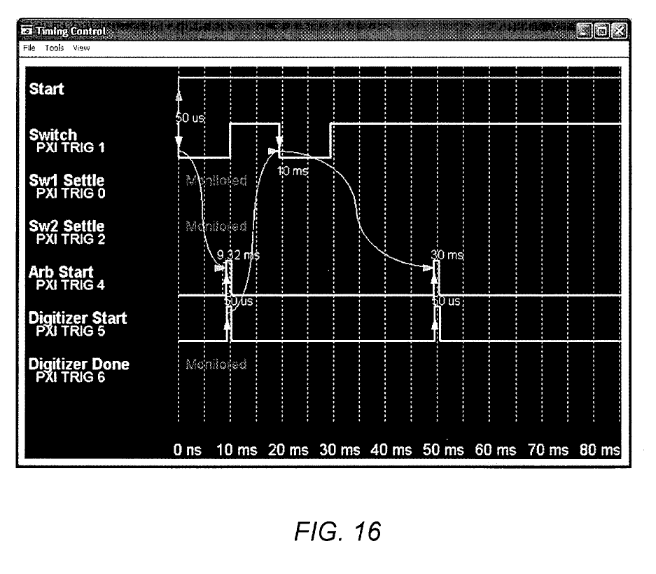

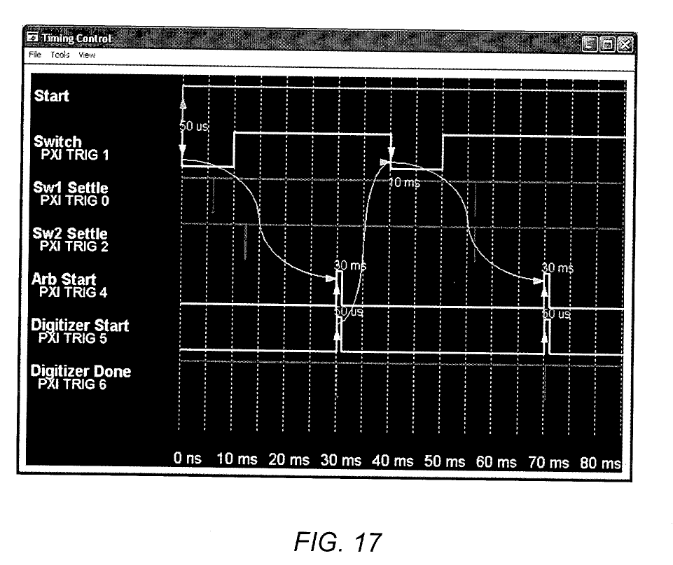

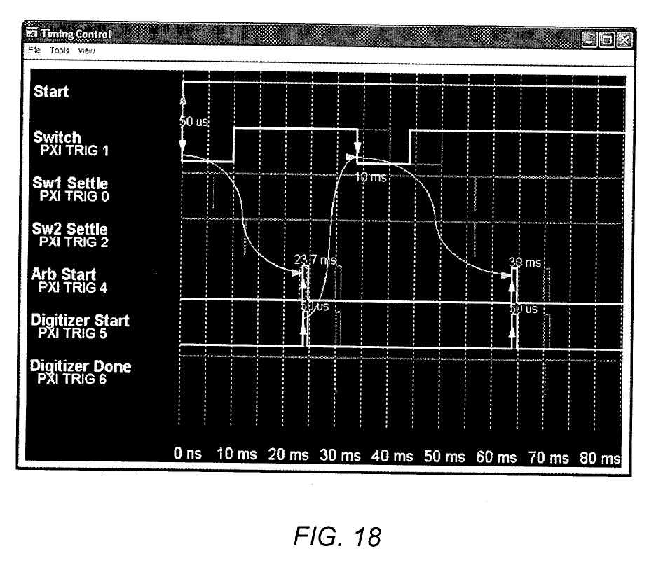

FIGS. 8-13 illustrate an example of a user creating a timing diagram. In the example of FIGS. 8-13, the user has created a trigger design. This example is described in greater detail below. FIGS. 15-18 also illustrate exemplary timing diagrams.

As a result of the user creating the timing diagram on the display, data structure(s) may be stored in memory which comprise information represented by the timing diagram. The data structures may store information regarding the names of the signals; time locations of their respective rising and/or falling edges; amplitudes of the signals, frequency and/or phase of any periodic signals; dependency relationships of the signals; names and/or types of devices which are to generate respective signals; signals to be monitored (including information on how the signals are to be monitored); and other information contained in the timing diagram.

In step 205, the method may operate to programmatically generate a graphical program based on the timing diagram created in 204. Thus, a software program, e.g., a GPG program, may analyze the timing diagram and generate a graphical program that corresponds to the timing diagram. For example, a graphical program generation (GPG) software program executing on the computer system may execute to analyze the timing diagram (e.g., analyze the stored data structure(s) that represent the timing diagram) and programmatically generate a graphical program that corresponds to the timing diagram. The GPG program may obtain the information on the names of he signals, time locations of their respective rising and/or falling edges, and the other information mentioned above as being stored in the data structure(s), and may use this information to programmatically generate the graphical program.

In generating the graphical program, the GPG program may programmatically create and display nodes in a block diagram and may create and display interconnections between the nodes. The graphical program may thus comprise a plurality of interconnected nodes which visually indicate functionality of the program. In one embodiment, after the user has drawn or specified the timing diagram, the user selects an option to invoke programmatic generation of a graphical program based on the timing diagram.

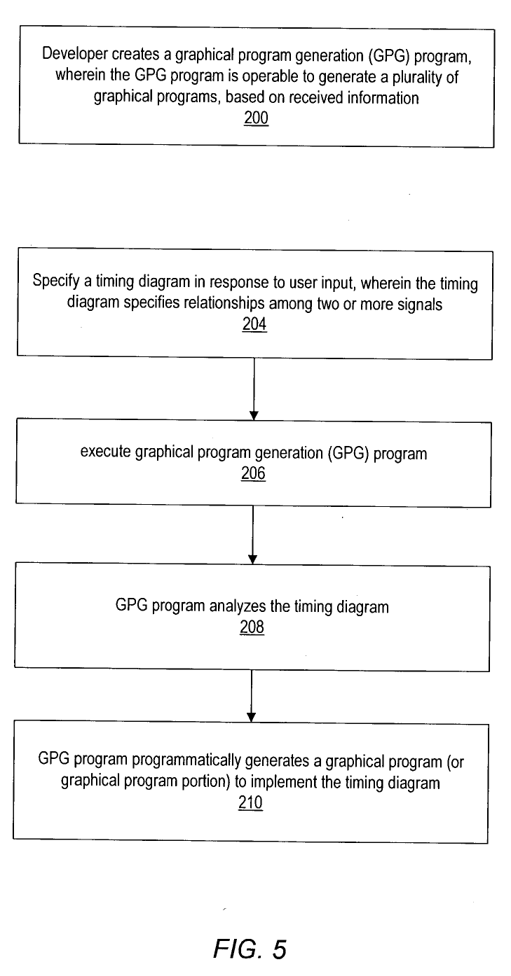

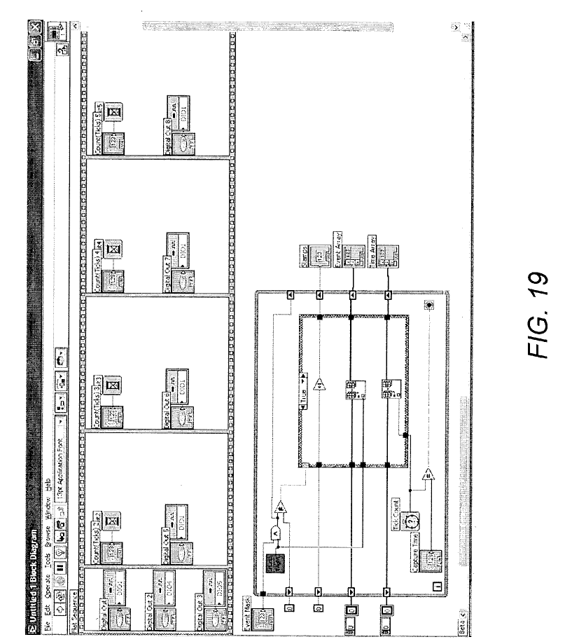

The generated graphical program may be executable to implement the timing diagram. For example, the generated graphical program may be executable to generate the signals according to the timing relationship shown in the timing diagram. An example graphical program created based on one of the timing diagrams shown in FIGS. 15-18 is shown in FIG. 19. One embodiment of step 205 is described in FIG. 5 below in steps 206, 208 and 210.

Where the user has specified signals to be monitored during operation of the system, a user interface or front panel may be created that is configured to display, or allow user modification, of the specified signals to be monitored. As shown, the user may adjust parameter values in GUI elements associated with either the timing diagram the graphical program in step 211. In response, in 212 the method may operate to automatically modify these tunable parameters in either the graphical program and/or the timing diagram, respectively.

After the graphical program has been created, the graphical program may then be further edited by the user, incorporated into another program, or executed as is. The graphical program may also be deployed to any of various devices. In one embodiment, portions of the graphical program may be deployed onto a plurality of different respective devices. In one embodiment, the graphical program (or at least a portion of the graphical program) may be deployed onto a programmable hardware element, such as an FPGA.

In one embodiment, a link may be maintained between the graphical program and the timing diagram. Thus, in one embodiment the user can adjust tunable parameters represented by GUI elements in either the timing diagram or the graphical program. The link between the graphical program and the timing diagram may cause changes made in one of the timing diagram or the graphical program to be automatically reflected in the other. Providing a link between the timing diagram and an executing graphical program also enables various feedback methods to be used. For example, a user can overlay a received signal on the timing diagram or timing description and compare the original timing signal and the received signal. Further, the user can link monitored triggers back to the timing diagram or timing description.

In one embodiment, the method may operate to generate multiple programs from the timing diagram, e.g., one for an FPGA and one for a host computer. For example, the same timing diagram may be used to generate programs for each of two or more different targets, e.g., an FPGA and a host computer. Alternatively, different portions of one timing diagram may be used to generate programs for each of two or more different targets, wherein the programs may execute in a distributed fashion to implement the timing diagram.

In one embodiment, the user may link input events to output events, e.g., a handshake signal. The user can draw a line in the timing diagram from an input event (e.g., a trigger) to an output event to indicate a causal relationship between the input event and the output event. The program generated from the timing diagram will then implement this causal relationship. One example of this is a dependency from a monitor trigger to an output event or triggered event.

### FIG. 5—Programmatic Creation of a Graphical Program

In prior systems, a user interactively or manually creates or edits a graphical program. For example, the user may interactively add various objects or icons to a graphical program block diagram, connect the objects together, etc. In contrast, one embodiment of the present invention comprises a system and method for programmatically generating a graphical program (or portion of a graphical program) without requiring this type of user interaction.

FIG. 5 is a flowchart diagram illustrating one embodiment of a method for programmatically generating a graphical program. In step 200, a graphical program generation (GPG) program may be created, wherein the GPG program is operable to programmatically generate a plurality of graphical programs, based on received information. As described below, the GPG program may be associated with any of various purposes or applications. Also, as discussed above, the GPG program may be implemented in various ways, e.g., using graphical and/or text-based programming environments. For example, the GPG program may be a text-based program, such as a program written using C, C++, Java, Basic, Visual Basic, FORTRAN, Pascal, or another text-based programming language. Also, the GPG program may itself be a graphical program. For example, the GPG program may be a graphical program interactively created in response to user input.

As described below, the GPG program may be implemented based on a client/server programming model. The client portion may call an application programming interface (API) provided by the server portion usable for programmatically creating the new graphical program. For example, a text-based GPG program may include text-based code for calling various API functions or methods, while a graphical GPG program may include various graphical nodes which are operable to invoke functions of the API. The creation of the GPG program may be performed by a developer, wherein the GPG program may be used as a tool for the programmatic creation of graphical programs by users or other developers.

As shown in step 204 and described above, a timing diagram may be created by the user. The timing diagram may be drawn on the display by the user, or specified in some other manner. In drawing the timing diagram, the user may specify relationships among two or more signals. As described below, this timing diagram may specify functionality of the new graphical program (or graphical program portion) to be generated. Data structures may also be created and stored which comprise information represented in the timing diagram.

In step 206, the GPG program may be executed. The GPG program may be executed in any type of computer system.

In step 208, the GPG program may receive or analyze the timing diagram specifying the functionality for the graphical program or graphical program portion.

In step 210, the GPG program may programmatically generate a graphical program or graphical program portion to implement the functionality specified by the timing diagram. In other words, in response to the timing diagram created in step 204, the GPG program may programmatically generate a new graphical program based on the timing diagram. In response to analyzing the timing diagram, the GPG program may process this information in order to determine how to generate the graphical program, i.e., in order to determine appropriate graphical source code for the program, an appropriate user interface for the program, etc. For example, the GPG program may analyze the names of the signals, the waveform or pulse characteristics of each of the signals, their timing relationships, whether a rising or falling edge of a signal is a triggering event, etc., and use this information to programmatically create appropriate source code that is executable to generate these signals.

In generating the graphical program, the GPG program may specify the inclusion of various objects in the new graphical program. For example, the new graphical program may have a diagram portion including a plurality of interconnected nodes which visually indicate functionality of the new graphical program. FIG. 19 illustrates an exemplary graphical program generated based on a timing diagram. The new graphical program may also have a user interface portion including various user interface objects, such as one or more user interface panels having controls for specifying user input to the graphical program and/or indicators for displaying output from the graphical program. For example, a programmatically created user interface may include controls for allowing the user to adjust one or more of the signals in the timing diagram. The GPG program may also specify other aspects of the graphical program, such as: connections between diagram objects and user interface objects, positions of objects, sizes of objects, and properties or configuration of objects (e.g., configuration of data types, parameters, etc.), among other aspects of the graphical program.

The graphical program may be programmatically generated with little or no user input received during this creating. In one embodiment, the graphical program is programmatically generated with no user input required. In another embodiment, the user may be prompted for certain decisions during programmatic generation, such as the type of graphical program, the look and feel of a user interface for the graphical program, the number or degree of comments contained within the graphical program, etc.

As described below, the determination of how to generate the graphical program may depend on a combination of the timing diagram and/or the program logic of the GPG program (i.e., what the GPG program is operable to do with the received information).

In various embodiments, the GPG program may generate a graphical program of any of various types. For example, the GPG program may generate the graphical program specifically so that a particular graphical programming development environment is operable to edit and/or execute the graphical program. For example, the GPG program may generate a LabVIEW graphical program.

In one embodiment, the GPG program may be a self-contained program that includes all executable logic necessary for programmatically generating the new graphical program. However, in the preferred embodiment, the GPG program utilizes a client/server programming model, in which the client portion processes the program information and determines the graphical program to be generated based on the program information (i.e., determines the function nodes or other objects to be included in the program, the interconnections among these nodes/objects, etc.). The client portion may then call an API provided by the server portion to request the server portion to perform the actual creation of the new graphical program, e.g., by creating files and/or other data structures representing the new graphical program. The server portion may execute on the same computer system as the client portion or may execute on a different computer system, e.g., a different computer system connected by a network. In one embodiment, the server portion may be an instance of a graphical programming development environment application, which provides an API enabling client programs to programmatically create and/or edit graphical programs.

The method of FIG. 5 is illustrated and is described above in terms of generating a new graphical program. It is noted that a similar method may be used to modify an existing graphical program, e.g., in order to add functionality to the program, such as functionality specified by user input received by a user interface wizard. In other words, instead of specifying creation of a new graphical program, the GPG program may specify the modification of an existing graphical program. When executed, the GPG program is then operable to programmatically modify the existing graphical program. For example, the GPG program may include a reference to the existing graphical program and may perform various API calls to modify the graphical program, e.g., by adding one or more objects to the graphical program, changing connections between graphical program objects, changing various properties of graphical program objects, etc.

It is noted that FIG. 5 represents one embodiment of a method for programmatically generating a graphical program, and various steps may be added, reordered, combined, omitted, modified, etc. For example, as described above, the GPG program may include or may be associated with an application that the user uses to specify the timing diagram. For example, a timing diagram creation tool used by the user for creating a timing diagram may also include the GPG program. Thus, executing the GPG program in step 206 may comprise invoking a routine or program associated with the timing diagram creation tool, e.g., in response to the user selecting a menu option included in the tool's or application's user interface. In other embodiments, the user may launch the GPG program as an independent application.

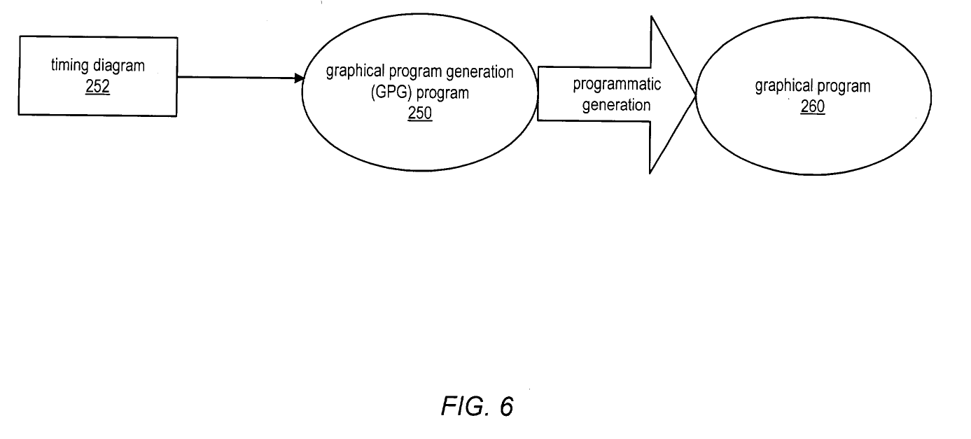

### FIG. 6—Examples of GPG Programs and Received Information

FIG. 6 is a block diagram illustrating programmatic generation of a graphical program based on a timing diagram. FIG. 6 illustrates a timing diagram 252 and a GPG program 250. The GPG program 250 receives the timing diagram 252 and programmatically generates the graphical program 260, as shown.

In some embodiments, the GPG program 250 may include or be coupled with a timing diagram creation program or application which a user utilizes to construct or characterize the timing relationships of the signals. In response to the specified timing diagram, the GPG program 250 may programmatically generate a graphical program to implement the timing diagram.

In other embodiments, the GPG program 250 may be associated with a program or application that directly aids the user in creating a graphical program. For example, the GPG program 250 may be associated with a graphical programming development environment application. In this case, the GPG program 250 may be operable to receive a timing diagram 252 and may automatically, i.e., programmatically, add a portion of graphical program code implementing the specified functionality to the user's program.

It is noted that in other embodiments the received timing diagram by itself may not explicitly or inherently specify complete functionality of the graphical program to be generated. In a case such as this, the functionality of the generated graphical program may be determined at least in part, or primarily, by the GPG program. Thus, one embodiment may include different “types” of GPG programs, wherein each type of GPG program is configured to generate graphical programs of a certain type.

Thus, in various embodiments, the functionality of the graphical program may be determined by the received program information, and/or the GPG program, and/or possibly also in response to user input received by the GPG program.

In various embodiments, an association between a generated graphical program and the timing diagram used in generating the graphical program may be maintained. For example, this association may enable a user to execute the automatically generated program and then return to the timing diagram, e.g., in order to view or edit the timing diagram. When the user edits a timing diagram that has an associated graphical program, the graphical program may be automatically updated accordingly. When the user edits a graphical program that has an associated timing diagram, the timing diagram may be automatically updated accordingly.

In various embodiments, the GPG program may be operable to generate any of various types of graphical programs. For example, as discussed above, a generated graphical program may be targeted toward a particular graphical programming development environment application, e.g., to utilize proprietary features or to create files that are formatted in a manner expected by the graphical programming development environment. Examples of graphical programming development environments include LabVIEW, BridgeVIEW, DasyLab, and DiaDem from National Instruments, VEE from Hewlett Packard, Simulink from The MathWorks, Softwire from Measurement Computing, Inc., Sanscript from Northwoods Software, WiT from Coreco, and Vision Program Manager from PPT Vision, among others.

In various embodiments, the graphical program may be generated using any of various methods or techniques. Generating the graphical program may comprise generating one or more files defining the graphical program. When a user interactively develops a graphical program from within a graphical programming environment, the graphical programming environment may create one or more program files. For example, the program files may specify information such as a set of nodes that the graphical program uses, interconnections among these nodes, programmatic structures such as loops, etc. In other cases, the program files may store various data structures, e.g., in binary form, which the graphical programming environment uses to directly represent the graphical program. Thus, in programmatically generating the graphical program, the GPG program may programmatically generate one or more files representing the graphical program, wherein these files are structured or formatted appropriately for a particular graphical programming environment.

In various cases, a graphical program generated by a GPG program in response to program information may be a fully working program. Thus, the user may load the generated graphical program into the graphical programming environment, execute the program, etc. In other cases, the generated graphical program may not be a complete program. As an example, if a timing diagram is translated to a graphical program, it may not be possible to convert the entire timing diagram. For example, the timing diagram may utilize functions which do not exist in the graphical programming environment to which the program is to be ported. However, the GPG program may still create a partial graphical program, making it relatively easy for the user to complete the graphical program. In still other cases, it may be desirable to programmatically generate only a graphical code portion, e.g., as discussed above in the case of user interface wizard tools that aid the user in program development.

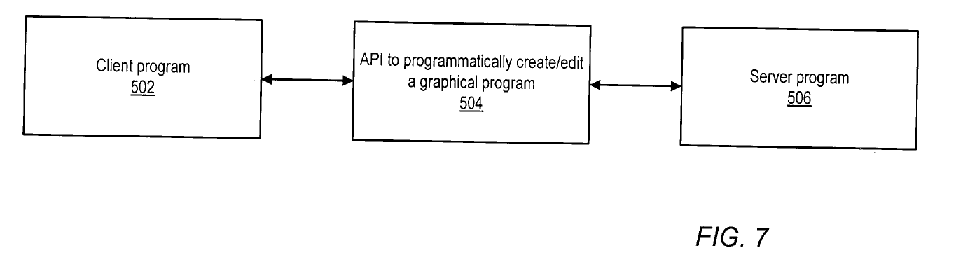

### FIG. 7—GPG Program Accesses Server Program Through an API

As described above, in one embodiment, the GPG program may be implemented as a client program and a server program, wherein the server program may provide an application programming interface (API) which the client program can use to programmatically generate the graphical program. One embodiment of such a client/server implementation of a GPG program is described below.

For each node, user interface element, or other object of the graphical program, the client program may call the API to programmatically add the object to the graphical program, connect the object to other objects of the graphical program, etc. Any necessary files or other constructs needed by the graphical programming environment in order to use the generated graphical program may be automatically created by the server program as a result of calling the API.

FIG. 7 is a block diagram illustrating the abstract relationship between a client program 502, an API 504 to programmatically create/edit a graphical program, and a server program 506. It is noted that the API block represents the abstract notion of the API presented by the server program 506, and in various embodiments the API block 504 may not represent any actual code. Also, in actual embodiments, various layers may exist which implement the elements of the FIG. 6 relationship. For example, the client program 502 may be a part of a larger software application, the server program 506 may receive information sent by the client program 502 via an intermediate server, etc.

As noted above, the client program 502 may be any of various types of programs. For example, the client program 502 may be a graphical program. The client program 502 may also be a text-based program such as a C++ program, a Visual Basic program, a Java program, etc., or any combination of these or other languages. The client program 502 may execute independently or may execute within an execution subsystem of an application development environment.

The client program 502 may call the API 504 in any of various ways. For example, a client graphical program may include graphical nodes corresponding to the API 504. One embodiment of a set of graphical nodes which a client graphical program may utilize to create/edit a graphical program is described in detail below. A client graphical program may also interface with text-based code which calls the API 504.

The client program 502 may also call the API 504 in various other ways. For example, the server program 506 may expose a component such as an ActiveX component, CORBA component, JavaBeans component, etc., and the client program 502 may obtain a reference to the object to invoke functions or methods of the API 504. The API 504 may also be integrated with the language or development environment of the client program 502, e.g. as a library.

Through the API 504, the client program 502 may communicate with the server program 506. The server program 506 is operable to perform the actions indicated by the API calls. For example, the server program may be operable to create a new graphical program, add objects to the graphical program, connect graphical program objects, etc. The server program 506 is preferably an instance of a graphical programming environment. In one embodiment, the server program 506 is an instance of the LabVIEW graphical programming environment. One particular embodiment of the server program 506 is described below.

In one embodiment, the server program 506 is the same regardless of the type of information (e.g., 252A-252F) that is received. Typically, the client program 502 will be different (or will use a different plug-in) based on the type of information, e.g. 252A-252F. Also, it is noted that the GPG program may be considered to be only the client program 502, wherein in this instance the GPG program 502 simply uses the services of a separate server program.

### Graphical API

The server program 506 of FIG. 7 may be operable to receive requests to generate/edit a graphical program from a client program 502 and perform the actual operations of creating/editing the graphical program. Thus, in the preferred embodiment, the client program 502 includes program logic for processing received program information and determining the structure of a graphical program to be generated based on the received program information, and the client program calls the server program to perform the generation of the graphical program (or to perform a modification to an existing graphical program).

In one embodiment, the server program 506 of FIG. 7 is an application instance of the LabVIEW graphical programming environment. As noted above, the LabVIEW environment provides specialized support for developers of instrumentation and industrial automation applications, and a LabVIEW graphical program may be referred to as a virtual instrument or VI. The LabVIEW environment comprises functionality referred to as “VI Server” which enables client programs to communicate with the LabVIEW environment. The VI Server functionality enables client programs to create or edit a LabVIEW graphical program or VI.

A client program which requests LabVIEW to generate/edit a VI may itself be a graphical program or VI. A client VI may include particular nodes in the client VI block diagram which utilize the VI Server functionality of a LabVIEW instance to request the LabVIEW instance to obtain information of an existing VI, create a new VI, add objects to the VI, etc. These nodes are described in U.S. patent application Ser. No. 09/745,023, referenced above, and incorporated by reference herein.

### FIGS. 8-13

FIGS. 8-13 illustrate one example of creation of a timing diagram according to one embodiment. This example illustrates creation of a timing diagram for a test system with a plurality of different devices including an arbitrary waveform generator (ARB) a source device and a switch controlled by a test device.

FIG. 8 illustrates the initial screen of a system timing designer program which shows a blank system timing description. As shown, FIG. 8 includes only a Start signal.

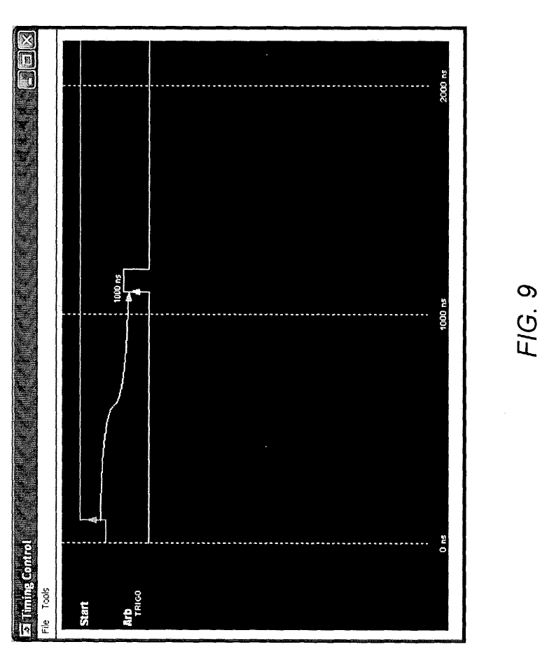

FIG. 9 illustrates a screen shot of the display where the user has added an arbitrary waveform generator signal to the time line referred to as ARB TRIG0. The TRIG0 signal will start waveform generation from PXI trigger 0. The arbitrary waveform generator will have a set of waveforms loaded for each test. FIG. 9 also illustrates the “link” signal which starts at the rising edge of the start signal and ends with an arrowhead at the rising edge of the TRIG0 signal. Although not shown in the black and white screen shot of FIG. 9, this link signal has a different color to visually indicate, e.g. yellow, to visually indicate that this represents a different operation. The link signal indicates that these two events are linked together and that the delay between these two events is also linked. Thus, the rising edge of the TRIG0 signal is specified to occur 1,000 nanoseconds after the rising edge of the start signal. The triangles on the edges of the respective signals represent an active edge of the trigger.

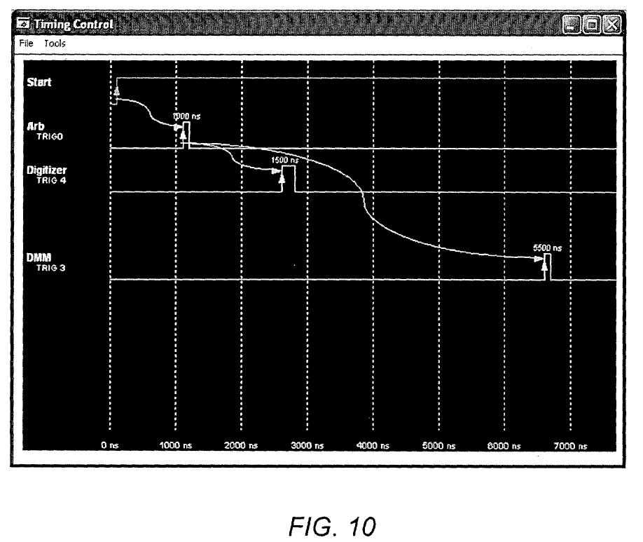

In the screen shot of FIG. 10, the user has added two measurements devices to the system on different PXI TRIGGER lines. As shown, the timing diagram includes a digitizer signal referred to as TRIG4 and a DMM signal referred to as TRIG3. The digitizer will measure the transient response, because the first test will be an impulse. The DMM will perform a DC reading at steady state to accurately measure the gain of the amplifier. Both measurements are linked to the start of the arbitrary waveform generation, as indicated by the links from the rising edge of the TRIG0 signal to each of the rising edge of the TRIG4 signal and the rising edge of the TRIG3 signal. In this example, where two measurement devices are used, a simple handshake between devices cannot be performed, and hence this system level timing tool provides an advantage to the user in designing his/her system.

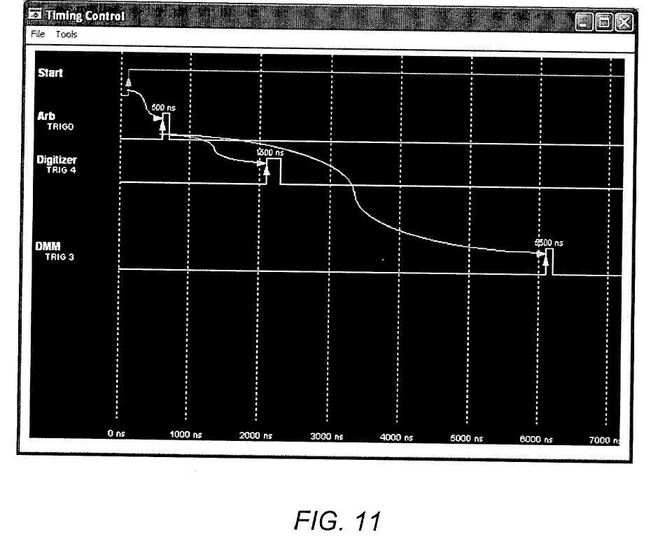

In the screen shot of FIG. 11, the user has moved the arb start time (the rising edge of TRIG0) 500 ns sooner. This may be accomplished by the user selecting the pulse or rising edge of the Arb TRIG0 signal using a mouse and moving or dragging it (using convention mouse drag and drop techniques) to the left by 500 ns. The user may also accomplish this using other input techniques. As shown, when the user performs this operation, the measurement relationships are maintained. In other words, when the user moves the Arb TRIG0 signal to the left by 500 ns, the other rising edges of the TRIG4 and TRIG3 signals move 500 ns as well to maintain their timing relationship with the Arb TRIG0 signal. Thus, after the user moves the Arb TRIG0 signal to the left by 500 ns, the TRIG4 and TRIG3 signals automatically move by the same amount so there is still a 1500 ns delay from the rising edge of the TRIG0 signal to the rising edge of the TRIG4 signal and there is still a 5500 ns delay from the rising edge of the TRIG0 signal to the rising edge of the TRIG3 signal. This occurs because of the links indicating the timing or measurement relationships between the signals. This demonstrates the advantages of representing timing as dependent events. The arb start time is moved 500 ns sooner, but the measurement relationships are maintained.

In the screen shot of FIG. 11, the user has configured two of the signal lines to be monitored. As shown, the user has configured the timing diagram to indicate monitoring of the Digitizer TRIG4 signal. This is visually indicated by the “End of Rec, Star Trig” entry on the left side of the timing diagram underneath the Digitizer Trig4 signal label. As shown, the legend “Monitored” appears to the right of the “End of Rec, Star Trig” entry. As shown, the user has configured the timing diagram to indicate monitoring of the DMM TRIG3 signal. This is visually indicated by the “VMC, Star Trig” entry on the left side of the timing diagram underneath the DMM TRIG3 signal label. As shown, the legend “Monitored” appears to the right of the “VMC, Star Trig” entry. In one embodiment using the PXI platform, the STAR trigger bus is used for signal monitoring. The STAR trigger bus provides a large number of lines available including those dedicated to a slot. Thus, in order to check the timing of a system in operation, one embodiment provides the ability to monitor trigger lines in the PXI system in addition to driving them. By monitoring the lines, the user can view the relationships of events in the system after it has been run.

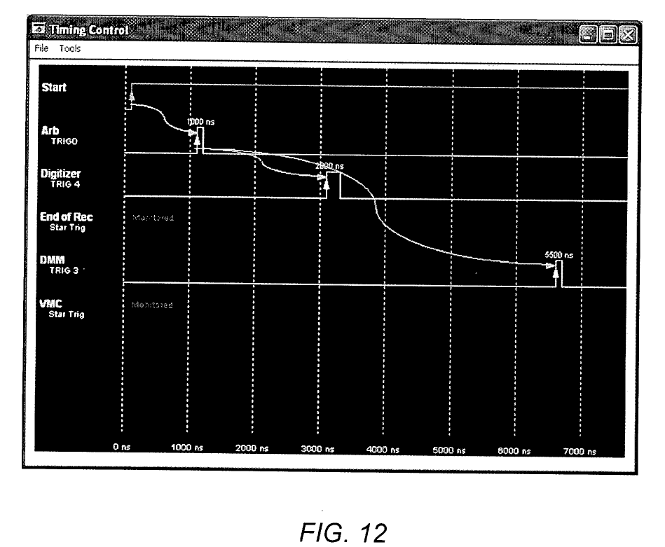

FIG. 12 illustrates the finished trigger design. As shown, the arb will go to the next waveform after the DMM measurement is complete.

As discussed above, in one embodiment a graphical program may be programmatically generated based on this timing diagram. The resultant graphical program may then be used to configure the hardware on the Slot 2 PXI controller in the measurement system. For even more sophisticated timing designs, the graphical program may then be converted into a hardware configuration program for deployment onto a programmable hardware device (e.g., an FPGA). For example, the method may use the LabVIEW FPGA or RIO technology as described in U.S. Pat. No. 6,219,628, referenced above. This would be especially important for complex trigger conditions and responsive timing where the power of a graphical programming language is important.

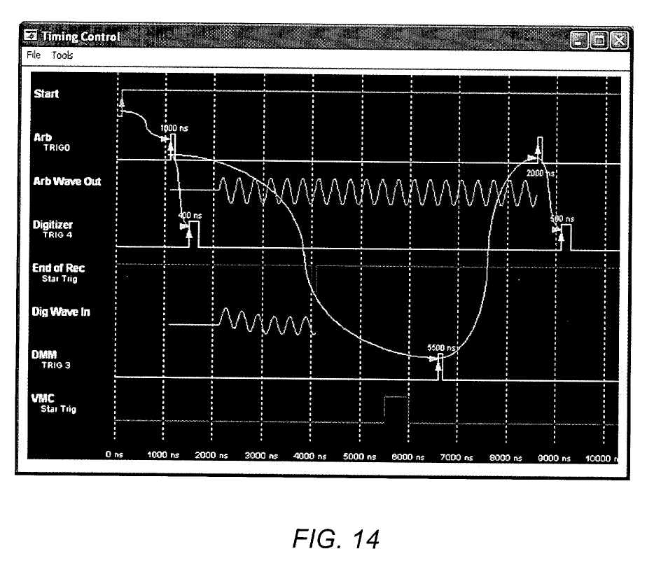

FIG. 14 illustrates the display after the test has been run. As shown, the monitored triggers are overlaid now with the system timing. Also, the source and digitizer waveforms are mapped on to the same graph. This allows the user to check that the measurements were made at the correct time and that enough settling time has been allowed between measurements. It is noted that the waveforms in this screenshot were artificially generated in the timing diagram for purposes of illustration, and are not properly aligned. One good example of the interactive nature would be to capture an impulse in the middle of the rise. The user could then slide the digitizer sample back and capture the full waveform. The user can also see the DMM measurement time and a switch settling time so the user can adjust the time line to optimize the timing. The user could actually bring in the Arb waveforms during design time since they are known.

FIGS. 15-18 illustrate example timing diagrams which may be created according to one embodiment of the invention.

FIG. 19 illustrates a graphical program generated based on a timing diagram, e.g., the timing diagram of one of FIGS. 15-18. As shown, the graphical program includes graphical code, i.e., a plurality of interconnected nodes, which is executable to generate the signals.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A computer-implemented method for creating a graphical program, the method comprising:
creating a timing diagram in response to user input, wherein the timing diagram specifies timing of two or more signals;
programmatically generating a graphical program based on the timing diagram.

2. The method of claim 1,
wherein the graphical program is executable to implement functionality specified in the timing diagram.

3. The method of claim 1,
wherein the graphical program is executable to control one or more devices to generate the two or more signals as shown in the timing diagram.

4. The method of claim 1, wherein said creating the timing diagram comprises displaying the two or more signals on a display in response to drawing commands entered by the user.

5. The method of claim 1, wherein said creating the timing diagram comprises specifying a relationship among at least two of the two or more signals.

6. The method of claim 5, wherein said specifying a relationship among at least two of the two or more signals comprises displaying a link between the at least two signals specifying, wherein the link visually indicates a timing relationship among the at least two signals.

7. The method of claim 5, wherein said specifying a relationship comprises specifying a delay relationship between edges of the at least two signals.

8. The method of claim 5,
wherein said creating the timing diagram includes:
creating a first signal and a second signal;
specifying a relationship between a first edge of the first signal and a second edge of the second signal;
adjusting a location of the first edge of the first signal in response to user input;
automatically adjusting a location of the second edge of the second signal in response to said adjusting a location of the first edge of the first signal.

9. The method of claim 1,
wherein the user is able to change timing relationships of some signals while not affecting the timing relationships of other signals.

10. The method of claim 1,
wherein said creating the timing diagram comprises storing at least one data structure in a memory, wherein the at least one data structure stores information regarding the timing diagram;
wherein said programmatically generating comprises programmatically generating the graphical program based on the at least one data structure.

11. The method of claim 1, wherein said creating the timing diagram comprises specifying at least one trigger signal.

12. The method of claim 1,
wherein the graphical program comprises a plurality of interconnected nodes that visually indicate functionality of the graphical program.

13. The method of claim 1, wherein said programmatically generating the graphical program comprises:
programmatically displaying a plurality of nodes on a display; and
programmatically interconnecting the plurality of nodes.

14. The method of claim 1,
wherein the graphical program comprises a block diagram portion and a user interface portion.

15. The method of claim 1,
wherein the graphical program comprises a graphical data flow program.

16. The method of claim 1,
wherein the graphical program is operable to perform one or more of:
an industrial automation function;
a process control function;
a test and measurement function.

17. The method of claim 1, further comprising:
executing the graphical program, wherein said executing comprises one or more devices generating the two or more signals according to the timing diagram.

18. The method of claim 1,
wherein said creating the timing diagram comprises specifying at least one signal to be monitored;
wherein said programmatically generating the graphical program comprises programmatically generating a user interface configured to display the at least one signal to be monitored.

19. The method of claim 1,
wherein said creating the timing diagram comprises specifying one or more GUI elements in response to user input;
wherein said programmatically generating the graphical program based on the timing diagram comprises creating the one or more GUI elements in the graphical program.

20. The method of claim 19,
wherein the one or more GUI elements correspond to parameters in the timing diagram that the user desires to adjust during execution of the graphical program.

21. The method of claim 20,
wherein the one or more GUI elements allow adjustment to a previously compiled timing diagram without recompilation of the timing diagram.

22. The method of claim 20, further comprising:
maintaining a link between the graphical program and the timing diagram;
wherein the parameters represented by the one or more GUI elements in one or more of the timing diagram or the graphical program are adjustable by a user;
wherein said maintaining a link operates to cause changes made in one of the timing diagram or the graphical program to be automatically reflected in the other.

23. The method of claim 1,
wherein the two or more signals specified in the timing diagram include a first signal;
the method further comprising:
executing the graphical program, wherein said executing comprises generating the first signal according to the timing diagram;
capturing the generated first signal; and
comparing the generated first signal with the first signal in the timing diagram.

24. The method of claim 1,
wherein said comparing comprises displaying the generated first signal overlaid on the first signal in the timing diagram.

25. The method of claim 1,
wherein said programmatically generating comprises programmatically generating a plurality of graphical programs based on the timing diagram.

26. The method of claim 1,
wherein said programmatically generating comprises programmatically generating a first graphical program to be executed by a first device and a second graphical program to be executed by a second device.

27. The method of claim 1,
wherein said programmatically generating comprises programmatically generating a first graphical program to be executed by a programmable hardware element and a second graphical program to be executed by a computer system.

28. The method of claim 1,
wherein said programmatically generating comprises programmatically generating a first graphical program based on a first portion of the timing diagram and programmatically generating a second graphical program based on a second portion of the timing diagram.

29. The method of claim 28,
wherein the first graphical program is operable to be executed by a first device and the second graphical program is operable to be executed by a second device;
wherein the first and second graphical programs are operable to be executed by the first and second devices in a distributed fashion to implement the timing diagram.

30. The method of claim 1,
wherein said creating the timing diagram comprises:
specifying at least one input event in response to user input; and
specifying at least one output event in response to user input.

31. The method of claim 30,
wherein said creating the timing diagram further comprises:
specifying a causal relationship between the at least one input event and the at least one output event in response to user input;
wherein the graphical program implements the causal relationship.

32. The method of claim 31,
wherein said specifying a causal relationship comprises drawing a line in the timing diagram from the at least one input event to the output event.

33. A memory medium comprising program instructions for creating a graphical program, wherein the program instructions are executable to implement:
creating a timing diagram in response to user input, wherein the timing diagram specifies timing of two or more signals;
programmatically generating a graphical program based on the timing diagram.
